(19) United States
(12) Patent Application Publication
(10) Pub. No.: US 2022/0281295 A1
(43) Pub. Date: Sep. 8, 2022

(54) VEHICULAR SUN VISOR

(71) Applicant: KYOWA SANGYO CO., LTD., Toyota-shi, Aichi (JP)

(72) Inventor: Nobuaki MATSUKI, Nissin-shi (JP)

(73) Assignee: KYOWA SANGYO CO., LTD., Toyota-shi, Aichi (JP)

(21) Appl. No.: 17/637,933

(22) PCT Filed: Aug. 25, 2020
(86) PCT No.: PCT/JP2020/032021

§ 371 Date: Feb. 24, 2022

(30) Foreign Application Priority Data
Aug. 27, 2019 (JP) 2019-154530

(51) Int. Cl. B60J 3/02

(52) U.S. Cl. CPC B60J 3/0278; B60J 3/0265

(57) ABSTRACT

A vehicular sun visor has a plate-shaped visor body, and a support shaft inserted into the visor body. The visor body is provided with a clip into which the support shaft is inserted. The outer peripheral surface of the support shaft includes a planar region that abuts the clip when the visor body is positioned in a storage position. The clip has a clip body made of elastically deformable metal, and has a pressing part that slidably abuts the outer peripheral surface of the support shaft including the planar region. The pressing part of the support shaft is applied with a surface treatment.

### TECHNICAL FIELD

The present invention relates to a sun visor provided in a vehicle. For example, the present invention relates to a sun visor including a plate-shape visor body and used such that the visor body rotates between a usage position along a windshield of a vehicle and a storage position along a ceiling.

### BACKGROUND ART

A vehicular sun visor described in Patent Document 1 includes a plate-shaped visor body, and a support shaft inserted into the visor body and supporting the visor body rotatably. The support shaft has a generally columnar shape. A gripper configured to grip the support shaft rotatably is provided inside the visor body. At the time when the visor body is rotated around the support shaft between a usage position along a windshield and a storage position along a ceiling, the gripper rotates together with the visor body while the gripper slides relative to the support shaft.

Generally, the rotation operation of the visor body is performed by hand. In view of this, it is desirable for the visor body to smoothly rotate around the support shaft. In the sun visor described in Patent Document 1, the support shaft and the gripper are coated with a thermoplastic material or the like, so that a sliding resistance between the support shaft and the gripper is reduced.

There has been known a sun visor configured such that a visor body is biased toward a ceiling when the visor body is brought close to the ceiling. The structure of the sum visor includes, for example, a planar region provided in part of the outer peripheral surface of a support shaft, and a leaf spring configured to abut with the outer peripheral surface of the support shaft while the leaf spring gives an elastic force to the outer peripheral surface of the support shaft. When the leaf spring rotates together with the visor body relative to the support shaft, an abutment part of the leaf spring that abuts with the support shaft approaches the planar region from an arc region of the support shaft. At this time, the leaf spring gives a biasing force to the support shaft, so that the visor body is biased to rotate toward the ceiling.

However, when the visor body hits the ceiling or the like at a speed faster than required, a large hammering sound may be caused. In order to deal with this, there is a request that the rotation speed of the visor body near the ceiling is restrained to reduce the hammering sound. In the meantime, it is conceivable to increase a sliding resistance between the support shaft and a gripper so as to slow down the rotation speed of the sun visor body. However, in a case where the sliding resistance is increased, when the visor body is to be rotated toward the ceiling by use of the biasing force from the leaf spring, the visor body may stop rotating before the visor body reaches the ceiling, and this may cause insufficient storage.
Patent Document 1: U.S. Pat. No. 6,120,084

### SUMMARY OF THE INVENTION

In view of this, conventionally, there has been required a sun visor which has contradictory functions of a function to smoothly rotate a visor body at a usage position and a function to reduce the rotating speed of the visor body at the time of bringing the visor body close to a ceiling by use of a leaf spring so as to reduce a hammering sound to be caused when the visor body hits the ceiling and which surely enables the visor body to reach the ceiling at the time when the visor body is brought into contact with the ceiling by use of the leaf spring.

According to one feature of this disclosure, a vehicular sun visor includes a plate-shaped visor body, and a support shaft configured to be inserted into the visor body such that the support shaft supports the visor body rotatably between a usage position and a storage position. A clip is provided in the visor body such that the support shaft is passed through the clip. An outer peripheral surface of the support shaft includes a planar region configured to abut with the clip when the visor body is placed at the storage position. The clip includes a metal clip body configured to elastically deform and an abutment region configured to slidably abut with the outer peripheral surface of the support shaft that includes the planar region. A surface treatment is performed on the abutment region of the clip.

Accordingly, a sliding resistance between the support shaft and the clip can be reduced by the surface treatment performed on the abutment region. Besides, the rotation speed at the time when the visor body rotates to the storage position after the visor body approaches a ceiling or the like can be reduced. This is because, as a result of diligent study of the inventors, it is found that a dynamic friction coefficient between the outer peripheral surface of the support shaft and the clip subjected to the surface treatment depends on the speed. That is, the clip moves to the ceiling together with the visor body by increasing its speed by use of the planar region of the support shaft. Meanwhile, the dynamic friction coefficient between the support shaft and the clip becomes larger as the speed becomes faster. As a result, the speed at the time when the visor body approaches the ceiling slows down, so that a hammering sound to be caused when the visor body hits the ceiling becomes small. On the other hand, when the speed of the visor body slows down, the dynamic friction coefficient of the clip becomes small. Thus, the sun visor has contradictory functions of a function to smoothly rotate the visor body and a function to reduce the speed at the time of storing the visor body, and the visor body can be surely stored in the ceiling.

According to another feature of this disclosure, the surface treatment is performed by coating the abutment region with a coating material having a characteristic that a dynamic friction coefficient increases as a sliding rotation speed of the clip relative to the support shaft becomes faster. Generally, at the time when the visor body moves toward the ceiling by use of an elastic force from the clip, the rotation speed of the visor body tends to become fast just before the visor body hits the ceiling. This tendency is relaxed when the dynamic friction coefficient of the clip relative to the support shaft increases. This consequently prevents the visor body from hitting the ceiling or the like at a speed faster than required. Thus, a hammering sound of the visor body to the ceiling that can be caused when the visor body is stored can be reduced.

According to another feature of this disclosure, the coating material for the surface treatment has such a characteristic that M obtained by dividing Δμ by ΔV is 0.03×10⁻² or more but 0.5×10⁻² or less when a speed V is 50 mm/sec. Here, ΔV represents a displacement amount of speed from an initial speed of 1 mm/sec to the speed V (mm/sec) when the clip slidably rotates around the support shaft. Further, Δμ represents a displacement amount of a dynamic friction coefficient μ between the clip and the support shaft at this time.

Accordingly, by performing the surface treatment, the sliding resisting force between the support shaft and the clip becomes larger as the sliding rotation of the visor body becomes faster, in comparison with a case where grease is applied between the support shaft and the clip as general in a conventional vehicular sun visor. Thus, a hammering sound to the ceiling that can be caused when the visor body is stored can be reduced.

### BRIEF DESCRIPTION OF THE DRAWINGS

FIG. 1 is a perspective view of part of an inner part of a vehicle and a sun visor attached to the vehicle.

FIG. 2 is a front view of the sun visor.

FIG. 3 is an exploded perspective view of a support shaft, a clip, and a case of the sun visor.

FIG. 4 is a perspective view of the clip.

FIG. 5 is an arrow view of a section taken along a line V-V in FIG. 4.

FIG. 6 is a side view illustrating a rotational state of a visor body around a horizontal shaft of the support shaft.

FIG. 7 is a sectional view illustrating the clip when the visor body is placed at a position R in FIG. 6.

FIG. 8 is a sectional view illustrating the clip when the visor body is placed at a position S in FIG. 6.

FIG. 9 is a sectional view illustrating the clip when the visor body is placed at a storage position K in FIG. 6.

FIG. 10 is a table illustrating the rotation speed of the visor body and the conversion clip speed for each actuation section of the visor body.

FIG. 11 is a graph illustrating the relationship of the angular velocity of the visor body at each position of the visor body.

FIG. 12 is a graph illustrating the relationship between the dynamic friction coefficient of the clip to the support shaft and the sliding velocity.

FIG. 13 is a graph illustrating values of M when a surface treatment is performed by use of coating materials containing various materials.

FIG. 14 is a graph illustrating the relationship between the dynamic friction coefficient of the clip to the support shaft and the sliding velocity at the time when the surface treatment is performed by use of some of the materials illustrated in FIG. 13.

FIG. 15 is a perspective view of a clip in another embodiment.

FIG. 16 is an arrow view of a section taken along a line XVI-XVI in FIG. 15.

FIG. 17 is a perspective view of a clip in another embodiment.

FIG. 18 is an arrow view of a section taken along a line XVIII-XVIII in FIG. 17.

### MODES FOR CARRYING OUT THE INVENTION

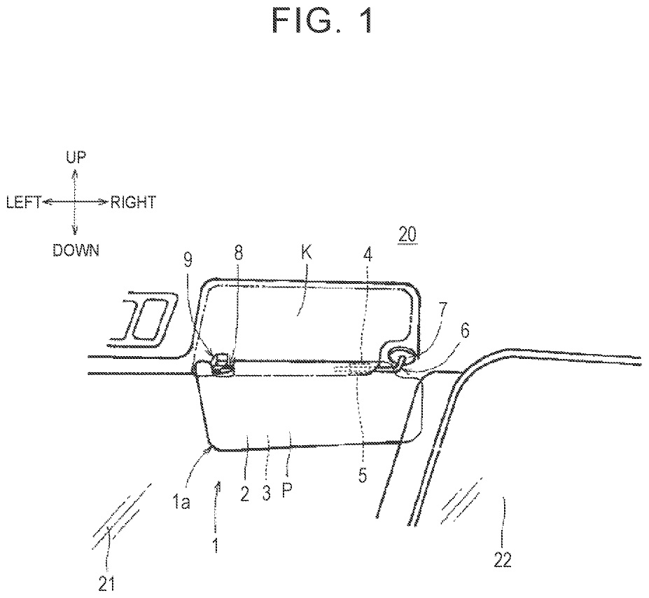

One embodiment of the present invention will be described with reference to FIGS. 1 to 3. As illustrated in FIG. 1, a vehicular sun visor 1 is attached to a ceiling surface 20 near a windshield 21. The vehicular sun visor 1 includes a visor body 1a constituted by a first component 2 and a second component 3 each having a generally plate shape. The surface of the visor body 1a is covered with a skin 11. A shaft 8 is attached to a hook 9, so that the visor body 1a rotates around the shaft 8 and a horizontal shaft 6a between a usage position P along the windshield 21 and a storage position K along the ceiling surface 20.

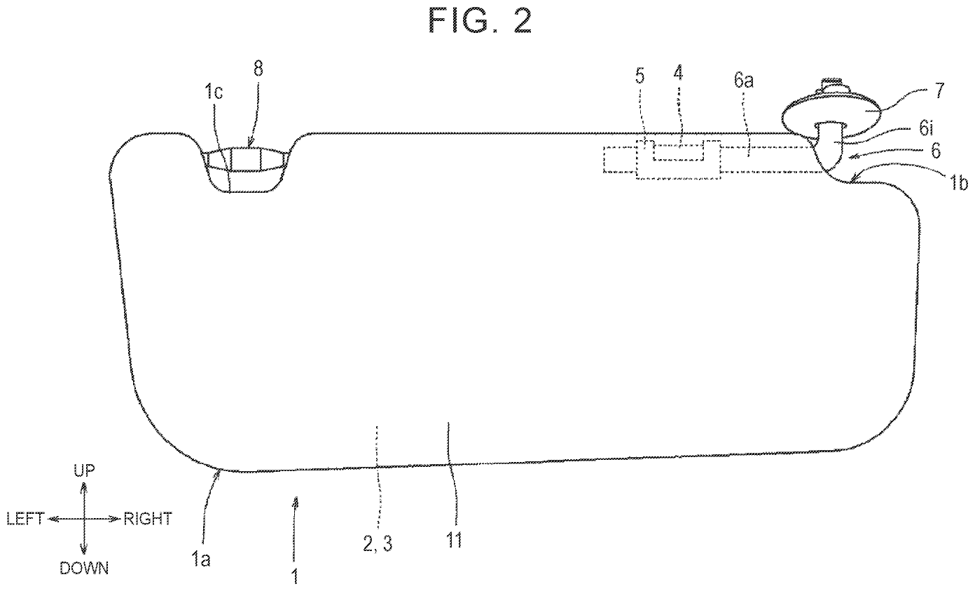

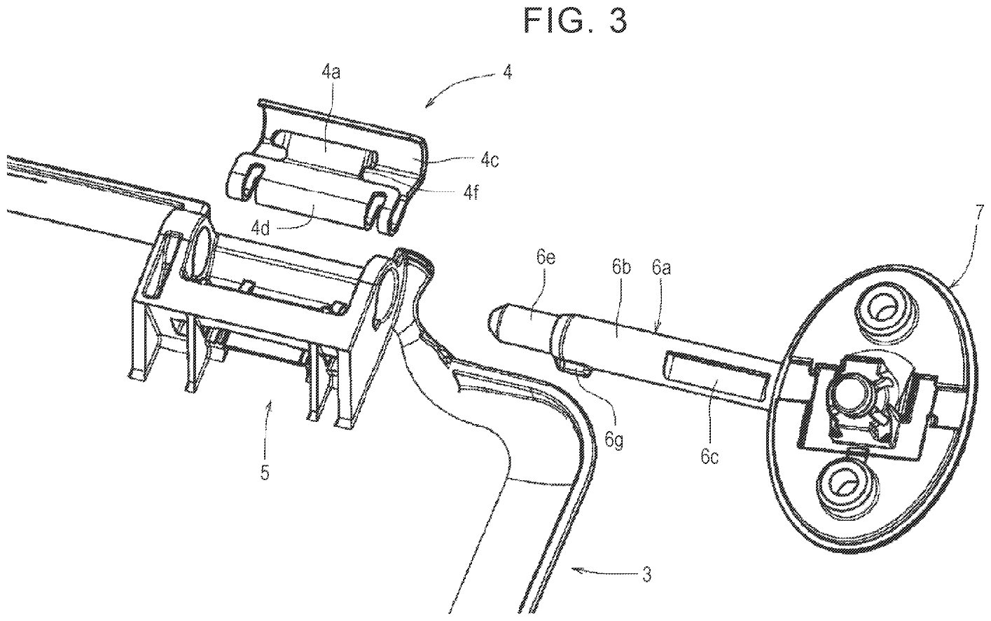

As illustrated in FIGS. 2, 3, the support shaft 6 is a generally L-shaped bar and includes the horizontal shaft 6a and a vertical shaft 6i. The horizontal shaft 6a includes a large-diameter portion 6b and a small-diameter portion 6e on the same axis. A generally rectangular slot surface 6c is formed on the outer peripheral surface of the large-diameter portion 6b. The support shaft 6 is made of resin containing polyamide-6 glass fiber (PA6GF). The support shaft 6 can be made of other materials such as iron, stainless steel, and PA6 (non-reinforcement), for example. The support shaft 6 is held in a case 5 provided in the visor body 1a, and the case 5 is provided with a clip 4 elastically abutting with the visor body 1a.

As illustrated in FIGS. 3 to 5, the clip 4 includes a clip body made of an elastically deformable metallic material. The clip body includes a surrounding part 4c and a U-shaped spring part 4d in an integrated manner. The surrounding part 4c has a generally L-shape and surrounds the outer peripheral surface of the horizontal shaft 6a such that the surrounding part 4c is pressed by the outer peripheral surface. Hereby, the surrounding part 4c gives a sliding frictional force to the outer peripheral surface of the horizontal shaft 6a.

The clip 4 integrally includes a pressing part 4a extending from a second end of the U-shaped spring part 4d toward the support shaft 6. The pressing part 4a extends with an inclination angle from a distal end of the U-shaped spring part 4d in a direction distanced from the second component 3. The pressing part 4a corresponds to the slot surface 6c of the large-diameter portion 6b. Accordingly, when the clip 4 rotates relative to the support shaft 6, the pressing part 4a moves between a position where the pressing part 4a abuts with the slot surface 6c and a position where the pressing part 4a is distanced from the slot surface 6c.

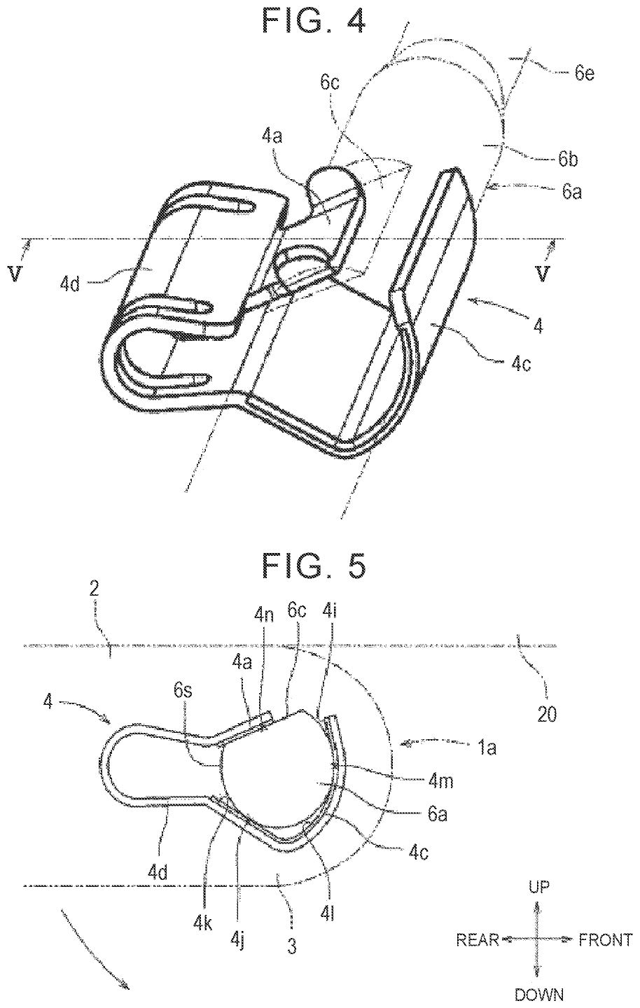

As illustrated in FIGS. 4, 5, when the visor body 1a is placed at the storage position K, the pressing part 4a of the clip 4 abuts with the slot surface 6c of the horizontal shaft 6a. Hereby, the visor body 1a is held with a predetermined inclination from the horizontal shaft 6a by use of an elastic force from the clip 4. Thus, the visor body 1a is held at the storage position K along the ceiling surface 20 by the elastic force from the clip 4.

As illustrated in FIG. 5, the clip 4 includes a resin coating 4i applied to part of the inner surface of the clip body. The resin coating 4i contains a binder and a solid lubricant. As the binder, a material obtained by mixing one or more types of resins such as polyamideimide-based resin (PAI), epoxy-based resin (EP), phenolic resin (PF), alkyd-based resin (ester-based resin), polyurethane-based resin (PUR), acrylic resin (PMMA), and poly ether ether ketone (PEEK) can be used, for example.

As the solid lubricant (additive), a material obtained by mixing one or more types of materials such as polytetrafluoro-ethylene (PTFE), molybdenum disulfide (MoS₂), carbon graphite (CG), silicon carbide (SiC), a silicon-based material, sodium silicate, titanium oxide (TiO₂), silica, talc, and carbon black can be used, for example.

Instead of the resin coating, another surface treatment can be performed on part of the inner surface of the clip body. For the surface treatment, a coating material containing electroless nickel plating (Ni—P), Zn (GEOMET (registered trademark)), boron, or the like can be used, for example. As a resin coating material, a material containing a fluorinated material such as PFA, FEP, ETFE, PVDF, PCTFE, or ECTFE can be used, for example. As a technique of the surface treatment, the clip 4 is dipped in the coating material. Alternatively, the coating material is applied to the clip 4 by spray. As other techniques, the surface treatment can be performed on the clip 4 by tumbling, vapor deposition, plating, peening, chemical treatment, or the like.

As illustrated in FIG. 5, the horizontal shaft 6a of the support shaft 6 abuts with the clip 4 at three abutting points or abutting surfaces. A first abutting point 4j is placed on a first surface 4k of the surrounding part 4c. A second abutting point 4m is placed on a second surface 4l of the surrounding part 4c. A third abutting point 4n is placed in the pressing part 4a. Note that respective positions of the three abutting points or abutting surfaces can move over the outer peripheral surface of the horizontal shaft 6a along with the rotation of the visor body 1a between the storage position K and the usage position P, respectively.

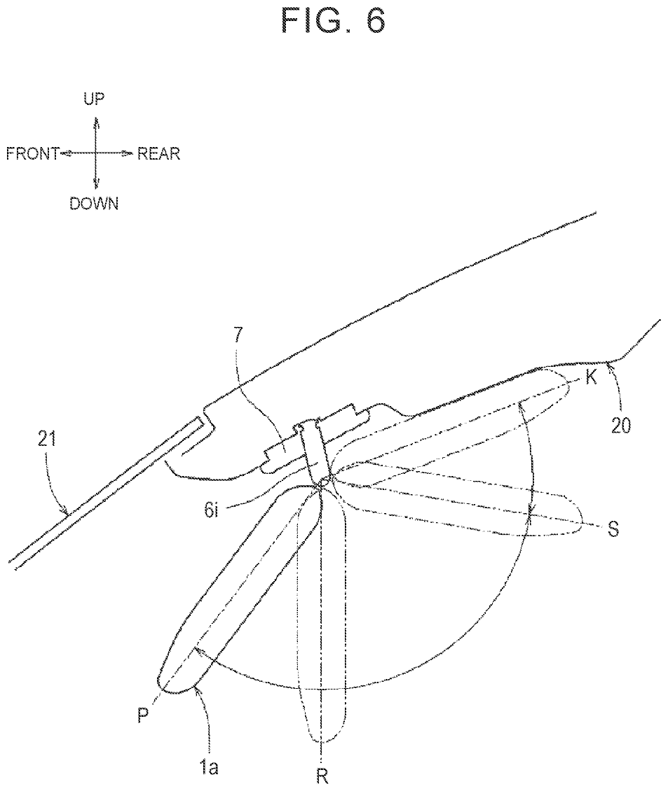

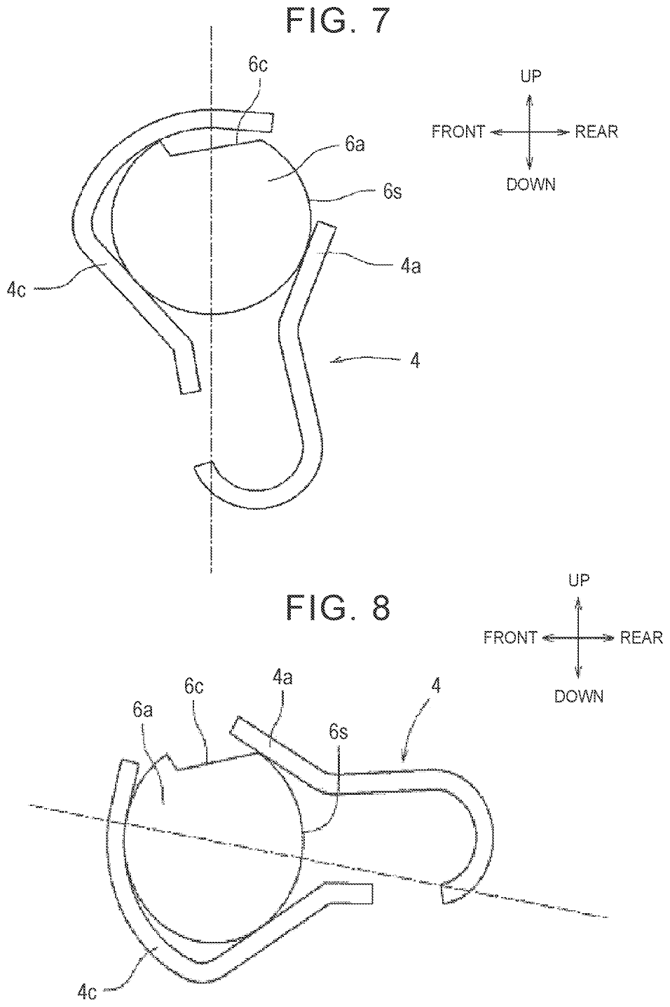

When the visor body 1a is stored in the ceiling surface 20, the visor body 1a is rotated around the horizontal shaft 6a from the usage position P to the storage position K as illustrated in FIG. 6. Here, from the usage position P to the position S, the visor body 1a is rotated by hand by a user. Along with this, the clip 4 is also rotated relative to the horizontal shaft 6a. More specifically, as illustrated in FIG. 7, the pressing part 4a of the clip 4 moves while the pressing part 4a abuts with an outer peripheral curved surface 6s toward the slot surface 6c. When the visor body 1a reaches the position S in FIG. 6, the pressing part 4a abuts with a boundary between the slot surface 6c and the outer peripheral curved surface 6s as illustrated in FIG. 8.

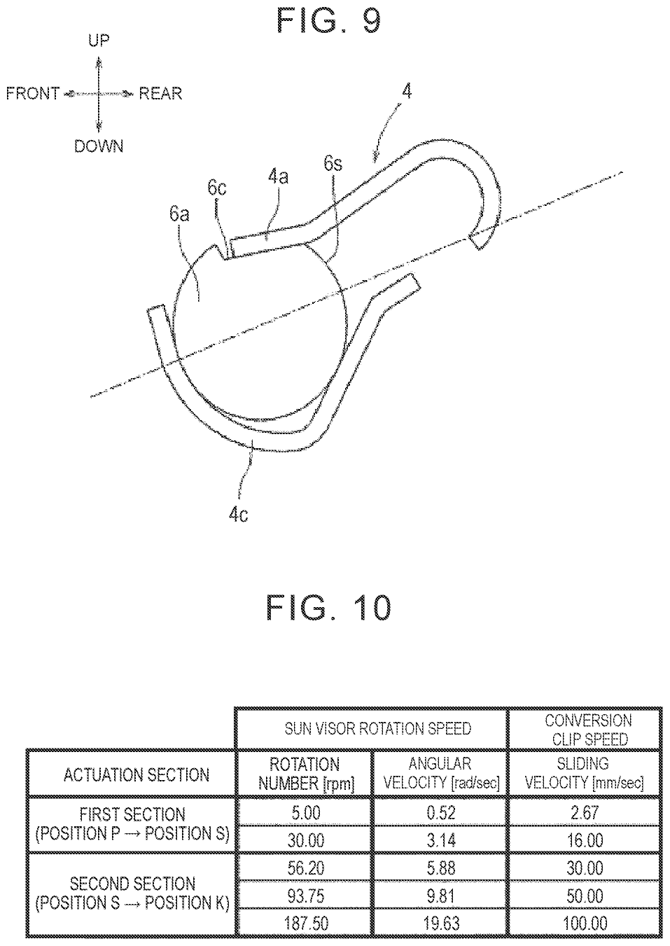

When the visor body 1a rotates from the position S toward the storage position K, the pressing part 4a is movable in a direction of the axial center of the horizontal shaft 6a as illustrated in FIG. 8. Hereby, the pressing part 4a gives a biasing force to the horizontal shaft 6a, so that the visor body 1a rotates toward the ceiling surface 20. Thus, the visor body 1a automatically rotates from the position S to the storage position K by the biasing force from the clip 4. When the visor body 1a is placed at the storage position K, the pressing part 4a abuts with the slot surface 6c of the horizontal shaft 6a as illustrated in FIG. 9.

An effect obtained by coating the clip 4 with the resin coating 4i was examined by experiment. First, speeds at the time of rotating the visor body 1a from the usage position P to the storage position K are summarized in FIG. 10. As actuation sections of the visor body 1a, a rotation from the usage position P to the position S illustrated in FIG. 6 is defined as a first section, and a rotation from the position S to the storage position K is defined as a second section. That is, in the first section, the visor body 1a is rotated by the hand of the user, and in the second section, the visor body 1a rotates upward by use of the elastic force from the clip 4.

Rotation speeds of the visor body in the actuation sections were measured in terms of a rotation number (rpm) and an angular velocity (rad/sec), and sliding velocities of the clip were obtained by conversion from measured values and summarized in the table of FIG. 10. The conversion was performed on the presumption that the diameter of the support shaft was 10.2 mm, and the circumferential length of the support shaft was about 32 mm. For the first section, two speeds were set as follows: a speed (5.00 rpm) at the time of starting to rotate the visor body 1a slowly by the hand of the user; and a speed (30.00 rpm) at the time of starting to rotate the visor body 1a relatively fast.

For the second section, three different speeds were set. These three speeds assume a case where the rotation speed of the visor body 1a in the first section varies and a case where the shape, the inclination angle, the position, or the like of the ceiling of the vehicle to which the vehicular sun visor 1 is mounted varies. From this table, it is found that the rotation speed of the visor body falls within a range from 56.20 rpm to 187.50 rpm in the second section. Generally, when the rotation speed of the visor body 1a in the first section was rapid, the rotation speed of the visor body 1a in the second section was also fast.

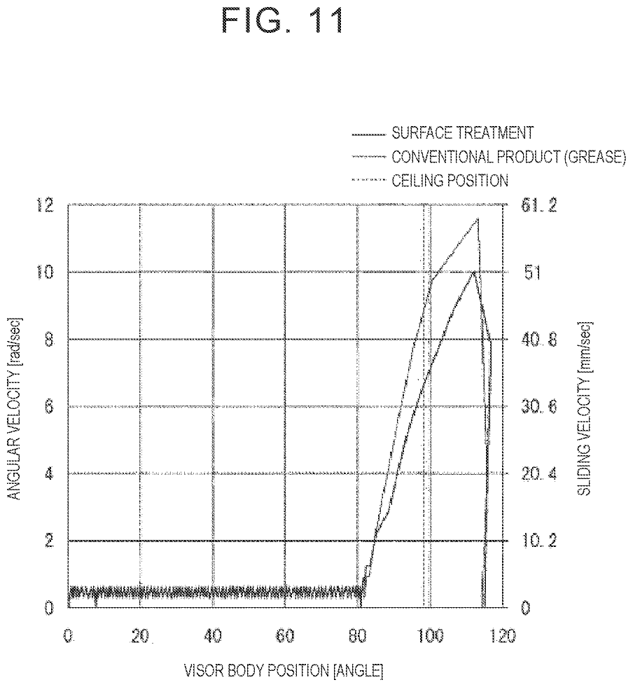

Subsequently, the clip 4 coated with the resin coating 4i of this disclosure and the clip 4 coated with grease were compared with each other by experiment in terms of the rotation speed (angular velocity) of the visor body 1a in the second section. In the graph of FIG. 11, the vertical axis represents the angular velocity (rad/sec), and the horizontal shaft represents the visor body position (angle). A visor body position from 0 degree to about 80 degrees corresponds to the first section in the actuation section, and a visor body position from about 80 degrees to about 100 degrees (a ceiling position) corresponds to the second section. In the first section, the visor body 1a was rotated by hand at a rate of about 5 rpm in any case. Note that an angular velocity at a visor body position larger than the ceiling position in the graph of FIG. 11 assumes a speed that the visor body 1a could achieve depending on the position, the shape, or the like of the ceiling.

According to the graph of FIG. 11, the angular velocity of the visor body 1a in the case of the clip 4 coated with the resin coating 4i is always lower than that in the case of the clip 4 coated with grease in the visor body position from about 80 degrees to about 100 degrees. Besides, the difference between the angular velocities increases as the visor body 1a approaches the ceiling position.

In order to find a dynamic friction coefficient of the resin coating 4i of the clip 4 to the support shaft 6 in each of the actuation section, the following friction test was performed. The measurement of friction coefficients was performed by use of an automatic frictional wear analyzer (Tsf-300 made by Kyowa Interface Science Co., Ltd.). More specifically, a test piece in which the outer peripheral surface of the clip 4 was coated with the resin coating 4i was prepared. For the resin coating 4i, a resin material containing polyamideimide-based resin (PAI) as a binder and containing polytetrafluoro-ethylene (PTFE) as a solid lubricant was used.

Subsequently, a plate corresponding to the support shaft 6 was prepared. More specifically, a plate made of PA6GF45 (obtained by adding glass fiber to nylon-6 at a weight ratio of 45%) was prepared. The outer peripheral surface of the clip 4 was brought into line contact with the plate at a normal load of 1 kgf. The clip 4 was slid over the plate by 40 mm in that state. The magnitude of a force to slide the clip 4 was found within a sliding distance range from 10 mm to 40 mm where the magnitude was stable. A friction coefficient was calculated from the measured value.

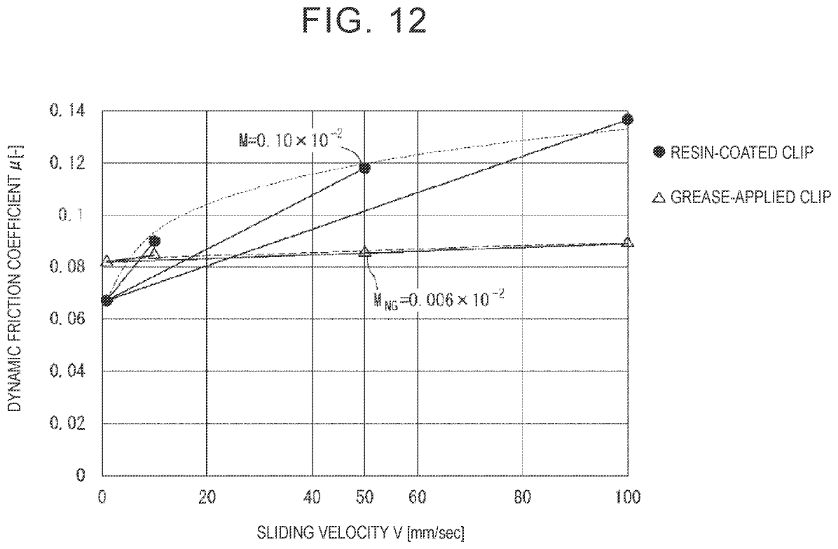

The measurement was performed under four conditions where the sliding velocity of the clip 4 was 1, 10, 50, 100 mm/sec. The friction test was performed at least five times under each condition, and a dynamic friction coefficient was calculated by averaging the friction coefficients obtained in the tests. Note that a test similar to the above was performed on the clip 4 coated with grease instead of the resin coating 4i as a target for comparison. Results of the tests are summarized in the graph of FIG. 12.

In the graph of FIG. 12, the vertical axis represents a dynamic friction coefficient μ, and the horizontal shaft represents the sliding velocity of the clip 4. According to the graph, in the case of the clip 4 coated with grease, the dynamic friction coefficient hardly changes regardless of the magnitude of the sliding velocity. In the meantime, in the case of the clip 4 coated with the resin coating 4i, when the sliding velocity is smaller than about 4 mm/sec, the dynamic friction coefficient is smaller than that of the clip 4 coated with grease. Further, there is such a tendency that, as the sliding velocity is larger, the dynamic friction coefficient is larger. The value of M in the graph of FIG. 12 is a value obtained by dividing Δμ by ΔV, where ΔV represents a displacement amount of the speed of the clip 4 from an initial sliding velocity of 1 mm/sec to a speed V (mm/sec), and Δμ represents a displacement amount of the dynamic friction coefficient μ at this time.

In the graph of FIG. 12, M_{NG} as a value of M in the case of the clip 4 coated with grease falls within a range of 0.006×10⁻² to 0.03×10⁻². On the other hand, in the case of the clip 4 coated with the resin coating 4i, the value of M falls within a range from 0.07×10⁻² to 0.26×10⁻². At a sliding velocity of 50 mm/sec, the value of M_{NG} is 0.006×10⁻². On the other hand, the value of M in the case of the clip 4 coated with the resin coating 4i is 0.10×10⁻².

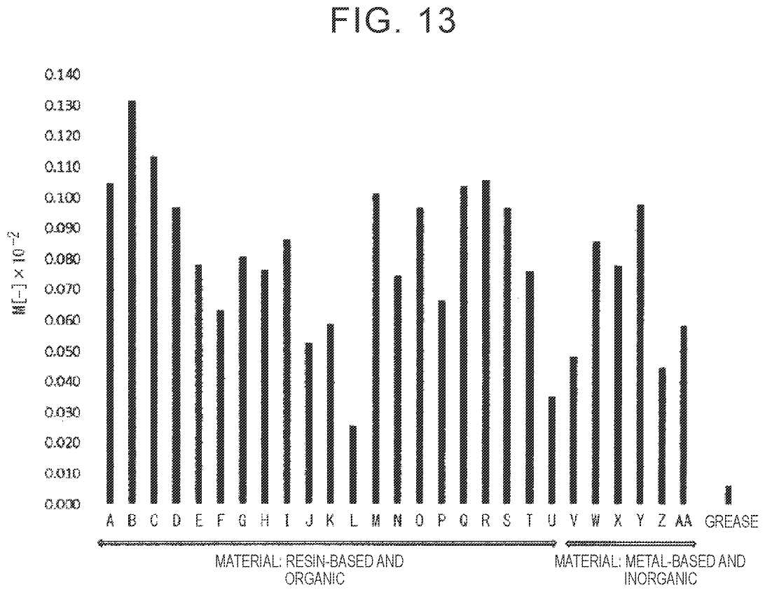

Subsequently, in order to examine effects to be obtained by different materials as the coating material, values of M to be obtained when various materials were used as the coating material were examined. More specifically, a friction test similar to the above was performed by use of resin-based and organic materials A to U and metal-based and inorganic materials V to AA illustrated in FIG. 13 as the coating material so as to find values of M at a speed of 50 (mm/sec). Note that a value of M was found by use of a clip coated with grease instead of the surface treatment as a target for comparison. According to the graph, grease exhibits the smallest value of M, and subsequently, the material L exhibits about 0.028×10⁻², the material U exhibits about 0.037×10⁻², and the material Z exhibits about 0.047×10⁻². The values of M of the other materials exceed 0.05×10⁻².

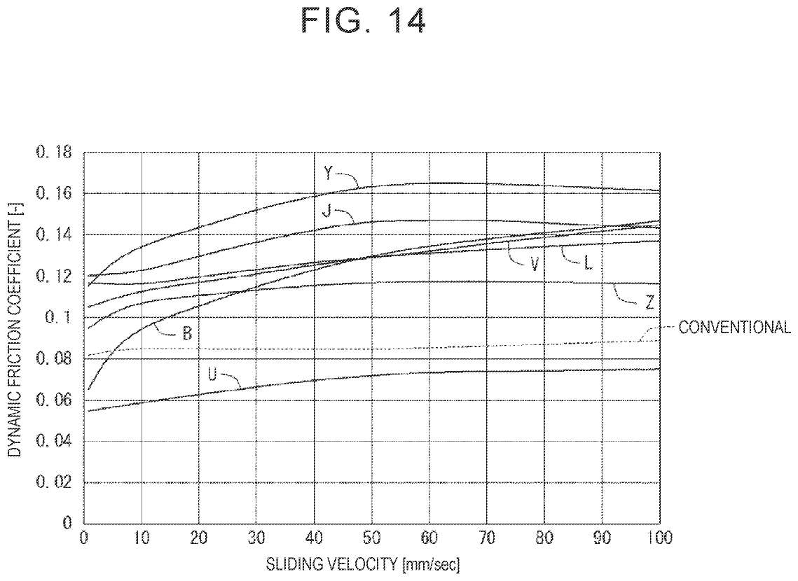

Subsequently, in order to examine the relationship of the value of M with the dynamic friction coefficient and the sliding velocity, the materials were divided into three groups based on the values of M illustrated in FIG. 13. A first group represents materials with M less than 0.03×10⁻², a second group represents materials with M equal to or more than 0.03×10⁻² but less than 0.05×10⁻², and a third group represents materials with M equal to or more than 0.05×10⁻². Further, some materials were extracted from each group for convenience. More specifically, the material L and the grease were extracted as the material of the first group, the materials U, V, Z were extracted as the material of the second group, and the material B, J, Y were extracted as the material of the third group. Based on them, a graph indicating the relationship between the dynamic friction coefficient and the sliding velocity was formed similarly to FIG. 12 and illustrated in FIG. 14.

As described above, the clip 4 subjected to the surface treatment such as the resin coating 4i exhibited such a tendency that, as the sliding velocity was larger, the dynamic friction coefficient was larger. Particularly, in a case where the value of M was larger than 0.03×10⁻², the tendency was exhibited. Further, in a case where the value of M was larger than 0.05×10⁻², the tendency was more conspicuously exhibited. Accordingly, in a case where the clip 4 is subjected to the surface treatment, when the clip 4 rotates in an accelerating manner, a larger kinetic friction force is applied to the clip 4. That is, as the rotation of the visor body 1a becomes faster, a sliding resistance in a direction opposite to the rotation is applied to the visor body 1a. Accordingly, by performing the surface treatment on the clip 4, it is possible to restrain an increase width in the rotation speed of the visor body 1a in the second section.

Generally, the kinetic energy E is expressed by E=½ mv². Here, m represents mass, and v represents speed. Accordingly, when the mass m is uniform, the kinetic energy E is proportional to the square of the speed v, and therefore, to reduce the speed v is effective for a reduction in the kinetic energy E. Accordingly, by performing the surface treatment on the clip 4, the kinetic energy of the visor body 1a at the time when the visor body 1a hits the ceiling becomes small. When the rotation speed at the time of storing the visor body 1a is reduced as such, a hammering sound that can be caused when the visor body 1a hits the ceiling surface 20 or the like can be reduced.

More specifically, in a case where the surface treatment was performed by use of a coating material that allows M to be equal to or more than 0.03×10⁻² at the time when the speed V of the visor body 1a is 50 mm/sec, the hammering sound was reduced by about 1 dB to 15 dB in comparison with a case where grease was applied. That is, a sufficient noise reduction effect to such an extent that an occupant can notice by the ear could be obtained by the surface treatment. In order to obtain a higher noise reduction effect, it is preferable to perform the surface treatment by use of a coating material having such a characteristic that the value of M is 0.05×10⁻² or more at the time when the speed V of the visor body 1a is 50 mm/sec.

As described above, the vehicular sun visor 1 includes the plate-shaped visor body 1a and the support shaft 6 inserted into visor body 1a, as illustrated in FIGS. 1 to 3. The visor body 1a is provided with the clip 4 through which the support shaft 6 is passed. The outer peripheral surface (6c, 6s) of the support shaft 6 includes a planar region 6c configured to abut with the clip 4 when the visor body 1a is placed at the storage position K. The clip 4 includes a metal clip body (4c, 4d) configured to elastically deform, and an abutment region (the pressing part 4a) configured to slidably abut with the outer peripheral surface of the support shaft 6 that includes the planar region 6c. The surface treatment is performed on the abutment region of the clip 4.

Accordingly, the sliding resistance between the support shaft 6 and the clip 4 can be reduced by the surface treatment performed on the abutment region. Besides, the rotation speed at the time when the visor body 1a rotates to the storage position K after the visor body 1a approaches the ceiling surface 20 or the like can be reduced. This is because, as a result of diligent study of the inventors, it is found that the dynamic friction coefficient between the outer peripheral surface of the support shaft and the clip subjected to the surface treatment depends on the speed. That is, the clip 4 moves to the ceiling surface 20 together with the visor body 1a by increasing its speed by use of the planar region 6c of the support shaft 6. Meanwhile, the dynamic friction coefficient between the support shaft 6 and the clip 4 becomes larger as the speed becomes faster. As a result, the speed at the time when the visor body 1a approaches the ceiling surface 20 slows down, so that a hammering sound to be caused when the visor body 1a hits the ceiling surface 20 becomes small. On the other hand, when the speed of the visor body 1a slows down, the dynamic friction coefficient of the clip 4 becomes small. Thus, the sun visor 1 has contradictory functions of a function to smoothly rotate the visor body 1a and a function to reduce the speed at the time of storing the visor body 1a, and the visor body 1a can be surely stored in the ceiling surface 20.

As illustrated in FIGS. 12, 14, the surface treatment is performed such that the abutment region is coated with a coating material 4i having such a characteristic that the dynamic friction coefficient becomes larger as the sliding rotation speed of the clip 4 relative to the support shaft 6 is faster. Generally, at the time when the visor body 1a moves toward the ceiling surface 20 by use of the elastic force from the clip 4, the rotation speed of the visor body 1a tends to become fast just before the visor body 1a hits the ceiling surface 20. This tendency is relaxed when the dynamic friction coefficient of the clip 4 relative to the support shaft 6 increases. This consequently prevents the visor body 1a from hitting the ceiling surface 20 or the like at a speed faster than required. Thus, a hammering sound of the visor body 1a to the ceiling surface 20 that can be caused when the visor body 1a is stored can be reduced.

As illustrated in FIG. 12, the coating material 4i of the surface treatment has such a characteristic that M as a value obtained by dividing Δμ by ΔV is 0.03×10⁻² or more but 0.5×10⁻² or less at the time when the speed V is 50 mm/sec. Here, ΔV represents a displacement amount of the speed from the initial speed of 1 mm/sec to the speed V (mm/sec) when the clip 4 slidably rotates around the support shaft 6. Further, Δμ represents a displacement amount of the dynamic friction coefficient μ between the clip 4 and the support shaft 6 at this time.

Accordingly, by performing the surface treatment, the sliding resisting force between the support shaft 6 and the clip 4 becomes larger as the sliding rotation of the visor body 1a becomes faster, in comparison with a case where grease is applied between the support shaft 6 and the clip 4. Thus, a hammering sound to the ceiling surface 20 that can be caused when the visor body 1a is stored can be reduced.

This disclosure is not limited to the appearance and the configuration described in the above embodiment, and various changes, addition, or deletion can be made within a range where the gist of the disclosure is not changed. For example, in the sun visor 1, the surface treatment is performed on only part of the clip 4 as illustrated in FIG. 5. Instead of this, the surface treatment may be performed on the whole surface of the clip 4.

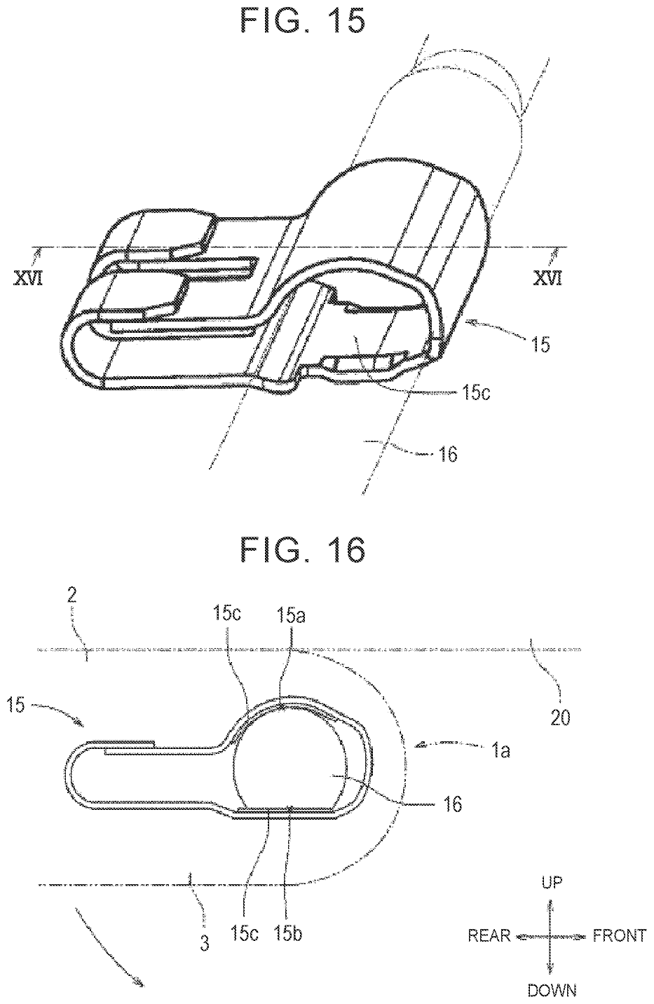

The sun visor 1 may include a clip 15 illustrated in FIGS. 15, 16 instead of the clip 4 illustrated in FIGS. 4, 5. As illustrated in FIG. 16, the clip 15 abuts with the horizontal shaft 16 at two abutting points or abutting surfaces 15a, 15b. A surface treatment 15c is performed to cover the abutting points or abutting surfaces 15a, 15b.

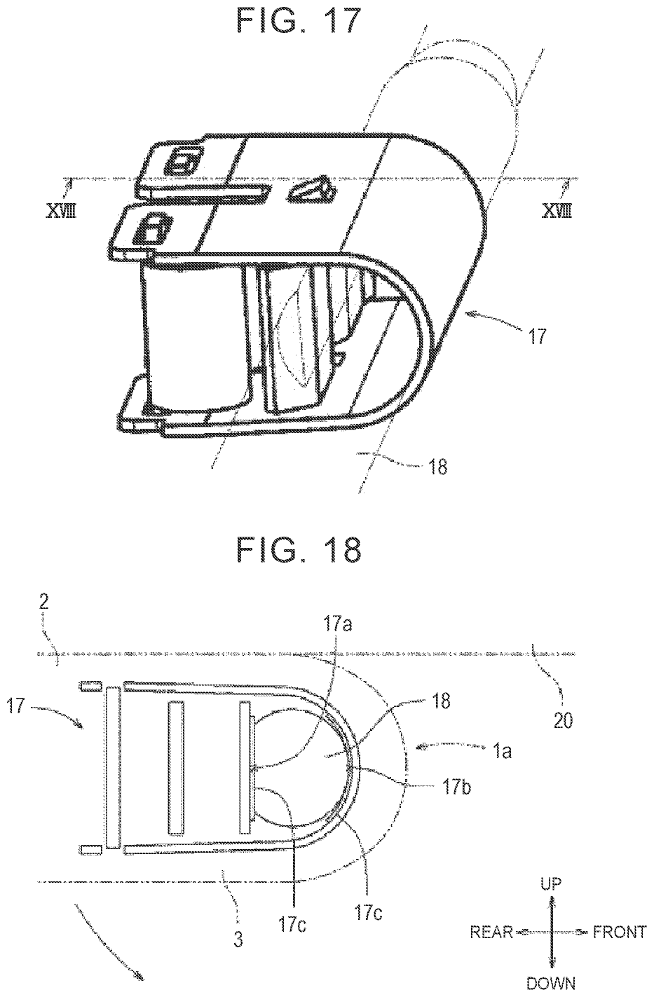

The sun visor 1 may include a clip 17 illustrated in FIGS. 17, 18 instead of the clip 4 illustrated in FIGS. 4, 5. The clip 17 abuts with a horizontal shaft 18 at two abutting points or abutting surfaces 17a, 17b. A surface treatment 17c is performed to cover the abutting points or abutting surfaces 17a, 17b.

The coating material for the surface treatment has such a characteristic that M is 0.03×10⁻² or more but 0.5×10⁻² or less at the time when the speed V is 50 mm/sec. Instead of this, the coating material may have such a characteristic that M is 0.05×10⁻² or more but 0.5×10⁻² or less at the time when the speed V is 50 mm/sec. The coating material may have such a characteristic that M is 0.05×10⁻² or more but 0.13×10⁻² or less at the time when the speed V is 50 mm/sec. Further, the coating material may have such a characteristic that M is 0.05×10⁻² or more at the time when the speed V falls within a range of 100 mm/sec or more.

### DESCRIPTION OF SYMBOLS

1/vehicular sun visor
1a/visor body
4/clip
4a/pressing part (abutment region)
4c, 4d/clip body
4i/coating material (resin coating)
6/support shaft
6c/slot surface (planar region)

1. A vehicular sun visor comprising:
a plate-shaped visor body;
a support shaft configured to be inserted into the visor body such that the support shaft supports the visor body rotatably between a usage position and a storage position; and
a clip provided in the visor body such that the support shaft is passed through the clip, wherein:
an outer peripheral surface of the support shaft includes a planar region configured to abut with the clip when the visor body is placed at the storage position;
the clip includes a metal clip body configured to elastically deform and an abutment region configured to slidably abut with the outer peripheral surface of the support shaft that includes the planar region; and
a surface treatment is performed on the abutment region.

2. The vehicular sun visor according to claim 1, wherein:
the surface treatment is performed by coating the abutment region with a coating material; and
the coating material has a characteristic that a dynamic friction coefficient increases as a sliding rotation speed of the clip relative to the support shaft becomes faster.

3. The vehicular sun visor according to claim 2, wherein:
the coating material is configured such that M obtained by dividing Δμ by ΔV is 0.03×10⁻² or more but 0.5×10⁻² or less when a speed V (mm/sec) is 50 mm/sec, where ΔV represents a displacement amount of speed from an initial speed of 1 mm/sec to the speed V when the clip slidably rotates around the support shaft, and Δμ represents a displacement amount of a dynamic friction coefficient μ between the clip and the support shaft at this time; and
the coating material has a speed dependence.
